(19) United States
(12) Patent Application Publication
(10) Pub. No.: US 2009/0121579 A1
(43) Pub. Date: May 14, 2009

(54) Curvilinear brush retainer and brushes for an electric motor assembly

(76) Inventors: David B. Finkenbinder, Ravenna, OH (US); Robert A. Ciccarelli, Kent, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/983,844

(22) Filed: Nov. 13, 2007

(51) Int. Cl. H01R 39/38; H01R 39/40; H02K 3/46

(52) U.S. Cl. 310/242; 310/270; 310/247

(57) ABSTRACT

A curvilinear brush retainer and brushes for an electric motor assembly comprises an end plate upon which is disposed a pair of curvilinear brush retainers. The brush retainers are configured to retain and support a pair of curvilinear brushes as they are biased against the commutator of the electric motor. The curvilinear profile or shape of the brushes allows them to have an extended physical length, thereby allowing the electric motor to have an extended operational life.

### TECHNICAL FIELD

The present invention is generally directed to electric motor assemblies. In particular, the present invention is directed to an electric motor assembly that utilizes molded curvilinear brushes so as to increase the length of the brush to extend the operating life of the electric motor. More particularly, the present invention is directed to an electric motor assembly that provides curvilinear brush retainers for aligning the curvilinear brushes with a commutator of the electric motor.

### BACKGROUND ART

Electric motors, such as DC (direct current) electric motors utilize carbon brushes in order to supply electrical current to a commutator that is rotatably carried by an armature of the motor. In the past, brushes have been formed to have a rectilinear or straight shape or profile, which has been generally adopted throughout the industry, and as a result are utilized in most DC electric motors.

Due to the design of DC or AC electric motors, the brushes are in continuous physical contact with the commutator during the operation of the motor. In addition, due to the switching by the commutator of the electrical currents supplied by the brushes, an amount of electrical sparking/arcing is generated. Thus, the combination of the physical and electrical stress imparted to the brushes during operation of the motor creates an operating environment that typically causes the brushes to wear out well before the failure of the other components of the motor. As such, brush failure serves as one of the primary sources of failures of DC motors. Although, the brushes may be replaced allowing the motor to continue in service, such an endeavor is tedious, time consuming, and costly.

To overcome the problem of reduced electric motor operating life due to brush wear, attempts have been made to extend the physical length of the brush so that the brushes can operate for a longer period of time. However, electric motors are generally incorporated into an existing assembly of electromechanical components that have been previously designed to have only enough area to accommodate motors that utilize standard brush lengths. Although, the physical arrangement of the surrounding electromechanical components surrounding the motor may be revised to accommodate longer length brushes, other design constraints associated with the overall assembly forming the completed device may also be impacted. Thus, a redesign of a significant portion of the completed product or device may be required to accommodate longer length rectilinear brushes.

Therefore, there is a need for curvilinear brushes for a DC electric motor that are able to provide extended brush life over that of typical rectilinear brushes. In addition, there is a need for a curvilinear brush retainer that is configured to support the curvilinear brushes without increasing the size of an end plate to which the motor is mounted. Furthermore, there is a need for a curvilinear brush retainer that includes a spring that is enabled to apply a force continuously in a single region of an end of the curvilinear brush throughout its operating life so as to reduce sparking between the commutator and the brushes during operation of the motor.

### SUMMARY OF THE INVENTION

In light of the foregoing, it is a first aspect of the present invention to provide a curvilinear brush retainer and brushes for an electric motor assembly.

It is another aspect of the present invention to provide an end plate for an electric motor having a shaft extending from a commutator, the end plate comprising a mounting portion having a first surface opposite a second surface, the mounting portion having an opening through which the shaft passes, a pair of curvilinear brush retainers disposed on the first surface, the retainers extending from the opening, so as to define a curvilinear path, and a pair of curvilinear brushes, one of which is guided by each curvilinear path toward the commutator.

Yet another aspect of the present invention is an electric motor unit utilizing curvilinear brushes, the motor unit comprising a motor assembly having a rotatable shaft, a fan assembly having a fan coupled to the shaft, and an end plate carrying the motor assembly and the fan assembly, the end plate comprising a plate portion having an attachment surface opposite an inlet surface, the plate portion having an opening through which the shaft passes, a pair of brush retainers disposed on the attachment surface, the brush retainers comprising a curvilinear outer member, and a curvilinear inner member that are spaced from each other, and which extend axially from the opening, so as to define a curvilinear path adjacent the commutator, the curvilinear path retaining a corresponding one of the brushes.

### BRIEF DESCRIPTION OF THE DRAWINGS

For a complete understanding of the objects, techniques and structure of the invention, reference should be made to the following detailed description and accompanying drawings, wherein:

FIG. 1 is an exploded perspective view of an electric motor unit that comprises a motor assembly and a fan assembly in accordance with the concepts of the present invention;

FIG. 2 is a perspective view of the fan assembly with the motor assembly removed and, in particular, an end plate having a curvilinear pair of brushes retained within a curvilinear brush retainer, the end plate is also shown with a shroud attached thereto in accordance with the concepts of the present invention;

FIG. 3 is a plan view of an attachment end of the end plate showing the curvilinear brushes in accordance with the concepts of the present invention;

FIG. 4 is another perspective view of the end plate without an attached shroud showing components of the curvilinear brush retainers in accordance with the concepts of the present invention;

FIG. 4A is another perspective view of the end plate showing a slot associated with the brush retainers;

FIG. 4B is another perspective view of the end plate in accordance with the concepts of the present invention;

FIG. 5 is a perspective view of an inlet end the end plate in accordance with the concepts of the present invention;

FIG. 6 is a plan view of the end plate without the curvilinear brushes in accordance with the concepts of the present invention;

FIG. 7 is a cross-sectional view of the end plate taken along line 7-7 of FIG. 6 in accordance with the concepts of the present invention; and

FIG. 8 is a cross-sectional view of the end plate taken along line 8-8 of FIG. 6 in accordance with the concepts of the present invention.

### BEST MODE FOR CARRYING OUT THE INVENTION

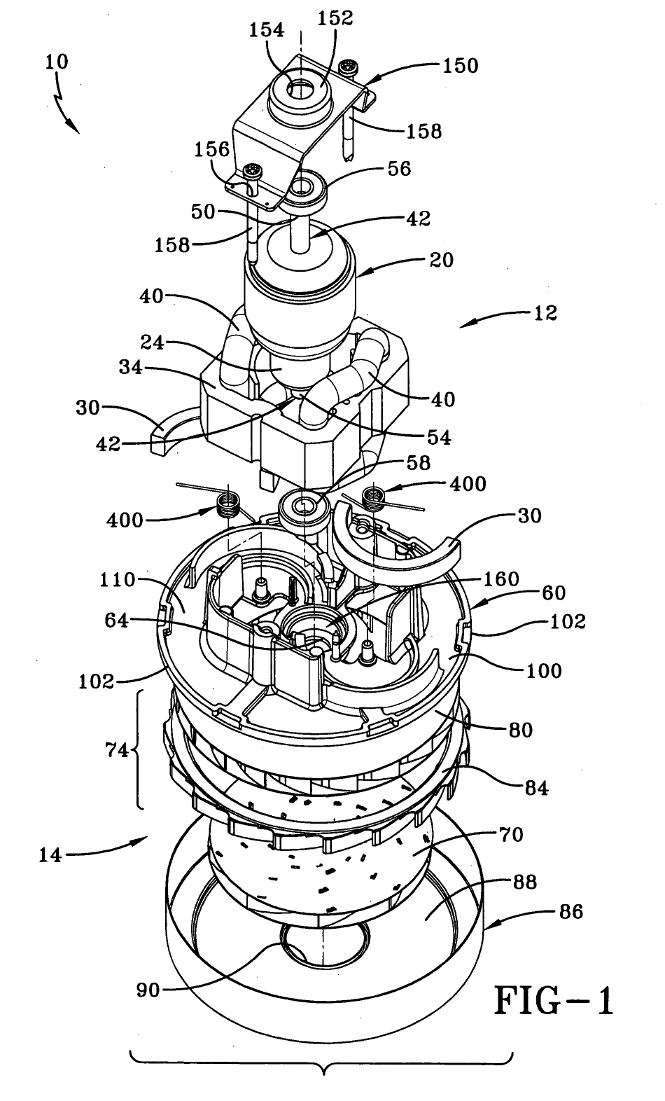

An electric motor unit, indicated generally by the numeral 10, and as shown in FIG. 1, generally includes a DC (direct current) motor assembly 12 and a fan assembly 14. The motor assembly 12 comprises an armature 20 that carries a commutator 24 that is configured to receive electrical current from a pair of curvilinear brushes 30. The armature 20 is rotatably disposed within a fixed lamination stack 34, which also contains various field windings 40. The armature 20 is carried by a shaft 42 that is rotatably supported at each end 50 and 54 by respective bearings 56 and 58. Although a DC motor assembly is shown, it will be appreciated that the concepts disclosed are applicable for use with AC motor assemblies.

During operation of the motor assembly 12, electrical current is supplied to the commutator 24 via the brushes 30, thereby allowing the armature 20 to rotate within the lamination stack 34 so as to provide a driving force to the end 54 of the shaft 42 which is proximate the fan assembly 14. The motor assembly 12 is supported by an end plate 60 attached to the end of the motor assembly 12 that is proximate the commutator 24, whereby the end plate 60 maintains a central aperture 64 through which the end 54 of the shaft 42 passes. Although the following discussion relates to the use of the end plate 60 with the fan assembly 14, it should be appreciated that the end plate 60 may be utilized independently, and as such may be used in conjunction with any assembly in which the driving force from the shaft 42 is needed.

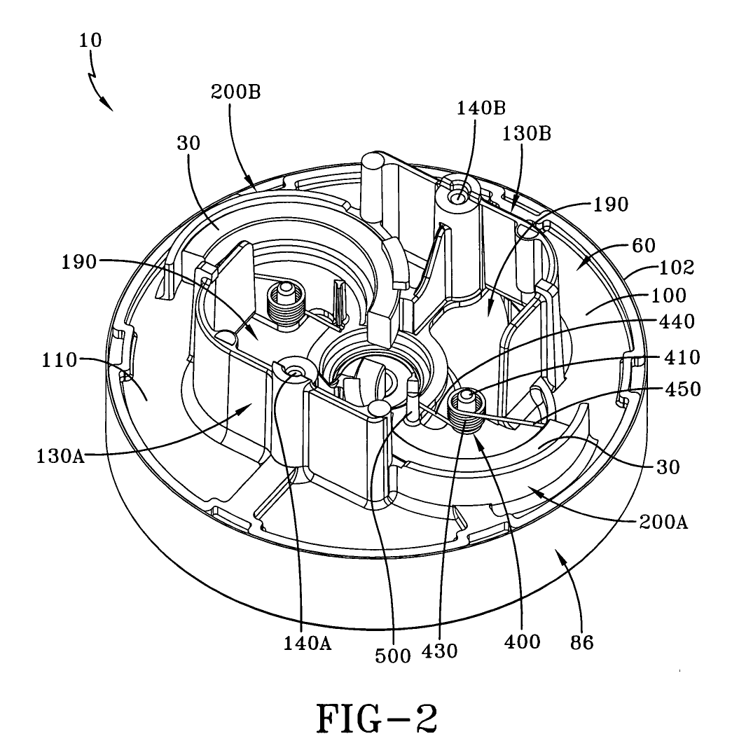

With regard to FIGS. 1 and 2, the fan assembly 14 comprises a fan 70 coupled to the end 54 of the motor shaft 42 via any suitable fastener (not shown), such as a nut for example. Interposed between the fan 70 and the end plate 60 is a diffuser assembly 74 that comprises a primary diffuser plate 80 and a secondary diffuser plate 84. As will be appreciated by the skilled artisan, the diffuser plates are configured to efficiently move air through the motor assembly. Although not shown, it will be appreciated that the diffuser plates and shroud could be configured as a radial or tangential bypass blower configuration. The diffuser assembly 74 is attached to the end plate 60, and as such remains in a fixed position with respect to the fan 70. Covering the outside of the fan assembly 14 is a shroud 86 that is connected to the end plate 60 using any suitable means, such as friction fit or staking for example. The shroud 86 includes a cover portion 88 that has a centrally disposed intake port 90 that is coaxially arranged with the axis of the shaft 42 of the motor assembly 12. The intake port 90 allows the fan assembly 14 to draw air into the shroud 86 where it is pressurized or otherwise compressed, and then supplied to the diffuser assembly 74 where it is exhausted into the inner portion of the shroud 86 and directed toward the motor assembly 12.

The end plate 60, which is the primary basis for the discussion that follows, is defined by a planar plate portion 100 having an edge 102. Although, shown as a planar portion in the FIGS., it should be appreciated that the plate portion 100 may comprise any desired shape. Furthermore, the end plate 60 may be formed from any suitable material, such as plastic, or other polymeric material. In one aspect, the end plate 60 may be formed from thermoset polyester. In yet another aspect, the end plate 60 may be formed using an “open and shut” molding process, although any other suitable manufacturing technique may be utilized in the formation of the end plate 60. Although a DC motor assembly is shown, it will be appreciated that the concepts disclosed are applicable for use with AC motor assemblies.

Continuing, the planar plate portion 100 includes an attachment surface 110 that is opposite an inlet surface 120. Extending substantially perpendicularly from the attachment surface 110 are a pair of motor brackets 130A and 130B that provide respective mounting bores 140A and 140B. The motor brackets 130A and 130B are spaced apart by a suitable distance to accommodate the dimension of the motor assembly 12 that is attached thereto.

The motor assembly 12 is attached to the motor brackets 130A and 130B by a retaining bracket 150 shown in FIG. 1. The retaining bracket 150 comprises a bearing retainer 152 having a central aperture 154 that is configured to be coaxial with the armature shaft 42. In addition, the bearing retainer 152 is configured to retain the bearing 56 therewithin so as to allow the end 50 of the shaft 42 to pass through, thus providing rotating support to the end 50 of the armature 20. The retaining bracket 150 also contains a plurality of retaining apertures 156 on either side of the bearing retainer 152, which are configured to align with the mounting bores 140A and 140B provided by the end plate 60. Suitable fasteners 158, such as screws are disposed through the retaining apertures 156 and received by the mounting bores 140A and 140B so as to retain the motor assembly 12 to the end plate 60.

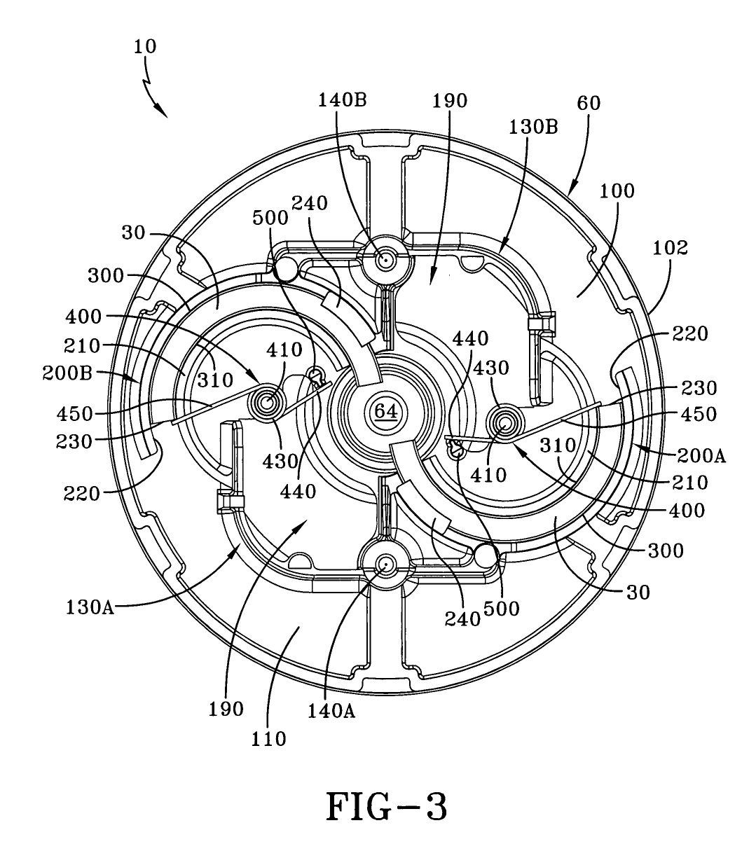

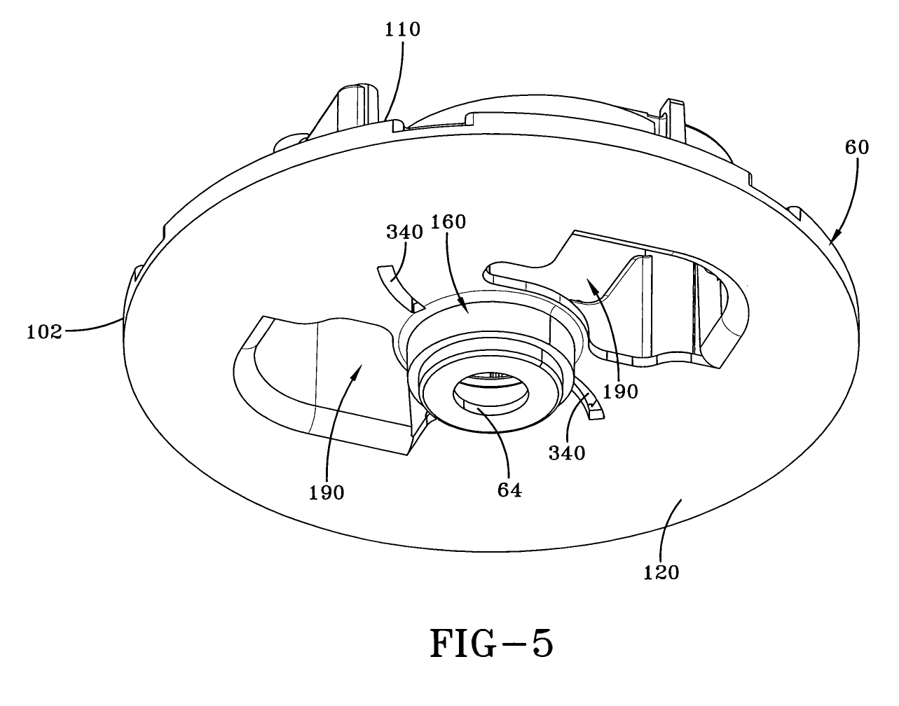

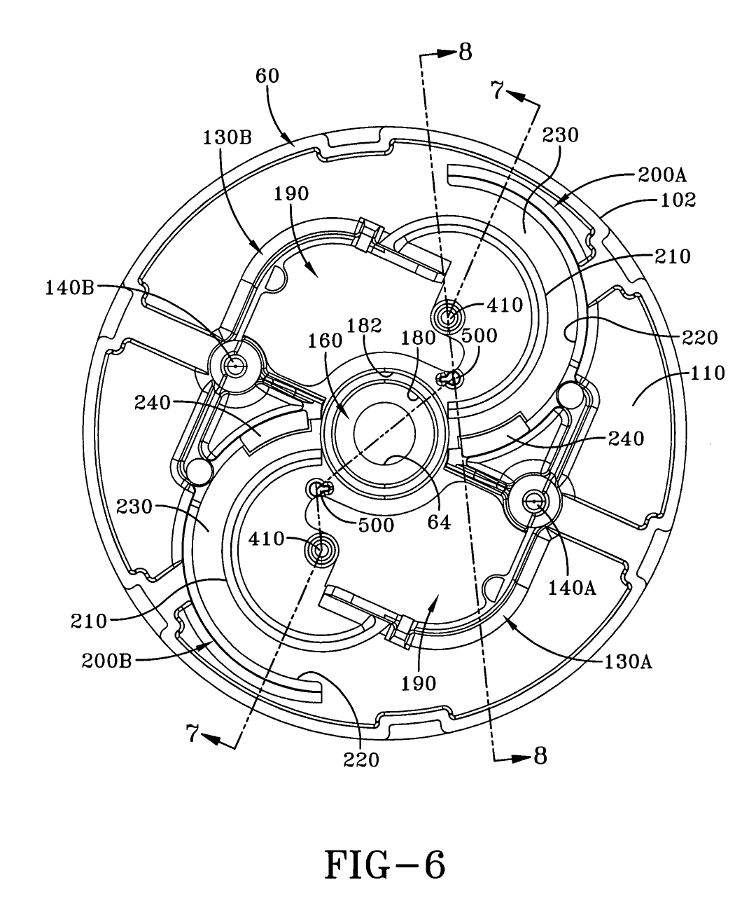

Disposed within the central region of the attachment surface 110 of the end plate 60 and extending therethrough is a central aperture 64 that is sized to allow the end 54 of the motor shaft 42 to extend therethrough for coupling to the fan assembly 14. As shown in FIGS. 3-10, the end plate 60 includes a commutator receiver 160, shown more clearly in FIGS. 9 and 10, which provides suitable clearance for the rotation of the motor shaft 42, while also retaining the bearing 58. Specifically, the commutator receiver 160 may extend axially outward from the inlet surface 120 of the end plate 60 to define a well 170. The well 170 includes a plurality of stepped concentric recesses 180 and 182 that accommodate the profile of both the commutator 24 and the bearing 58 received therein. Specifically, recess 180 is configured to retain the bearing 58 used to rotatably support the end 54 of the armature shaft 42, whereas the recess 182 provides clearance for the commutator 24.

To allow cooling air to pass over the armature 20 and brushes 30, the end plate includes a pair of cavities 190 that are disposed through the planar plate portion 100 of the end plate 60 in a region between the motor mounts 130A-B and the commutator receiver 160. Thus, when the motor assembly 12 is attached to the end plate 60, air drawn into the shroud 86 by the fan 70 is exhausted through the cavities 190 and flows over the armature 20 and brushes 30.

In order to maintain the brushes 30 in electrical contact with the commutator 24 during operation of the motor assembly 12, a pair of curvilinear brush retainers 200A and 200B are provided upon the attachment surface 110 of the end plate 60. Because the curvilinear brush retainers 200A and 200B are substantially equivalent in structure, with one being a mirror image of the other, the following discussion is directed to that of only brush retainer 200A.

As shown in the FIGS., particularly FIGS. 2-4 and 8-9, the brush retainer 200A is curvilinear in shape and is comprised primarily of four members: an inner member 210, an outer member 220, a support member 230, and a retention member 240. The members 210-230 coact to form an arcuate or otherwise curvilinear path through which the brush 30 is received and able to readily slide or sweep, allowing the brush 30 to continuously remain in contact with the commutator 24. The brush retainers 200 are integrally formed and extend from the plate portion 100. As such, separate brush holder tubes do not need to be maintained or secured to end plate 60 for the purpose of carrying the brush.

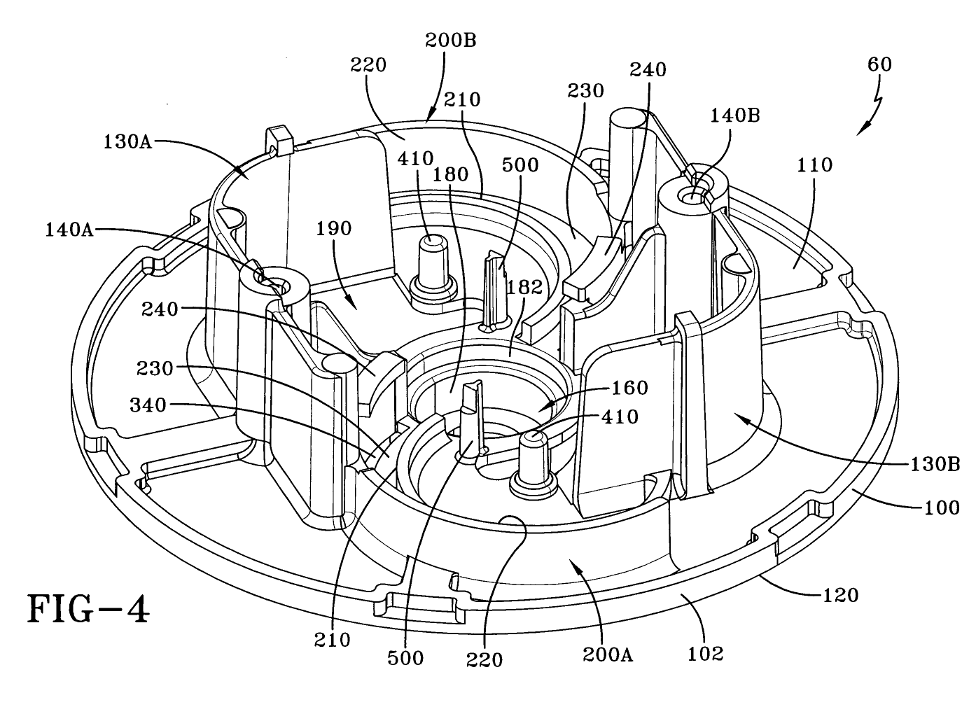

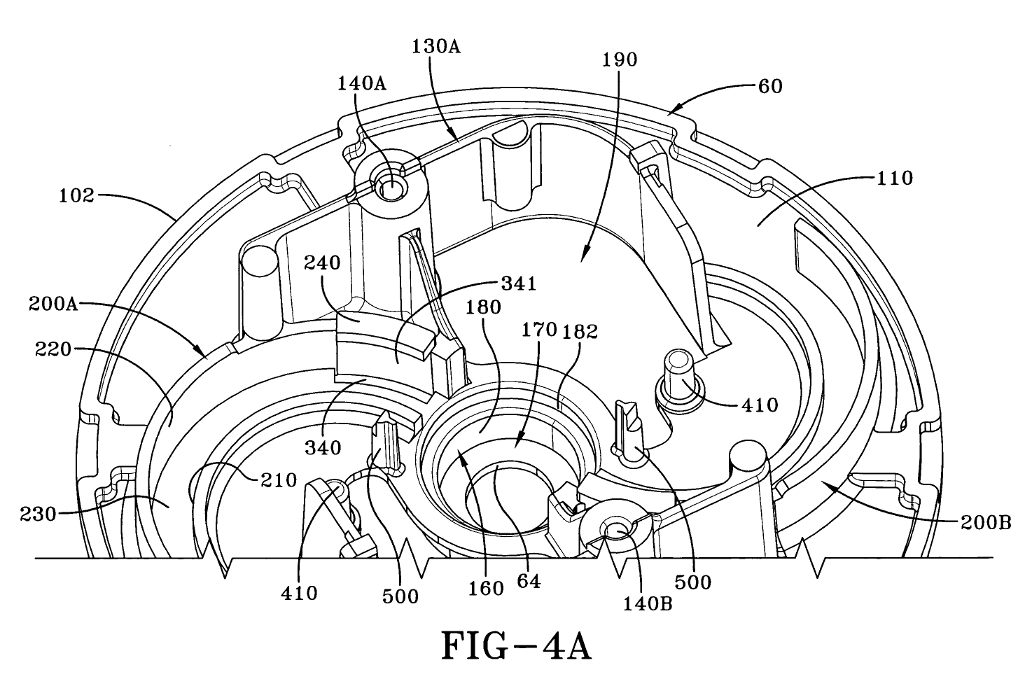

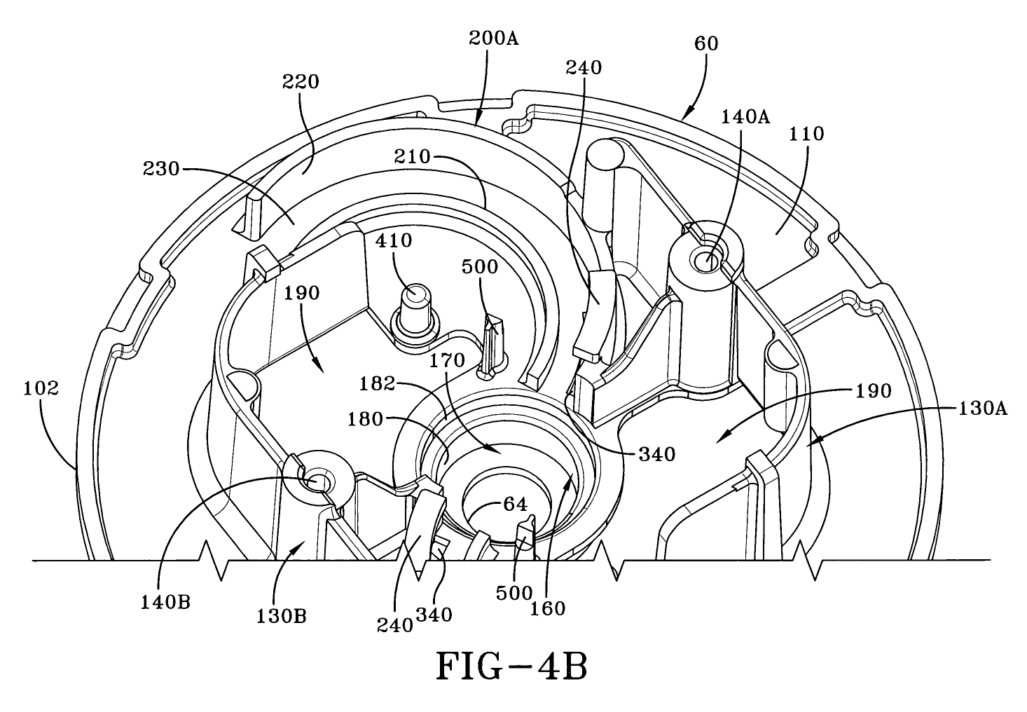

As shown in FIGS. 4A and 4B, the inner member 210 and the outer member 220 extend axially outward and substantially perpendicularly from the attachment surface 110 of the end plate 60 toward the motor assembly 12. Additionally, the inner member 210 and the outer member 220 are substantially concentric with each other, and are spaced apart by the support member 230 so as to define a curvilinear path that matches the curvature of the curvilinear brush 30. However, it should be appreciated that the concentric relationship between the inner and outer members 210, 220 is not required.

The curvilinear brushes 30, as shown in FIGS. 1-3, are typically comprised of electrically conductive carbon material that is formed to have a curvilinear shape. The curvilinear shape may be formed from a molding process or other suitable technique. The curvilinear profile or shape of the brushes 30 allow them to have an increased length dimension over that of standard rectilinear brushes, without extending beyond the edge 102 of the end plate 60. Such a characteristic of the curvilinear brushes 30 allows the operating life of the motor unit 10 to be extended without consuming additional area in and about the region of the end plate 60. In other words, because the brush retainers 200A and 200B, as well as the brushes 30 do not extend beyond the edge 102 of the end plate 60, the end plate 60 can be utilized in devices where the component area about the motor 12 is constrained, while providing increased operational life to the motor unit 10. Furthermore, the end plate 60 may be configured such that it can accommodate the curvilinear brush retainers 200A and 200B while the end plate is able to maintain a dimension that is the same as end plates that are used to maintain rectilinear brush retainers used for rectilinear brushes.

The outer members 220 and the inner members 210 are dimensioned to extend from the attachment surface 110 of the end plate 60 a distance to provide suitable support to respective outer and inner surfaces 300 and 310 of the brush 30. Because the brush 30 is primarily being guided by the inner member 210, it is not required to extend the full height of the brush 30. In one aspect, the inner member 210 may extend from the end plate 60 by comparatively less than the outer member 220 extends. As such, the path formed by the outer and inner members 220, 210 and the support member 230, which extends between the members 210 and 220, extends in a curvilinear manner from a region within the boundary of the planar plate portion 100 to a region proximate the commutator receiver 160.

In the region of the brush retainer 200A proximate the commutator receiver 160, the retention member 240 extends from the outer member 220 toward the inner member 210 substantially perpendicularly, while simultaneously following the curvature of the outer member 220. It should be appreciated that the retention member 240 may span only a partial amount of the distance between the outer and inner members 220, 210. Furthermore, the retention member 240 may be configured so that it extends only a partial length of the outer member 220. As such, the retention member 240 is dimensioned primarily to prevent the brush from sliding upwardly out of the brush retainer 200A. Likewise, the outer member 220 functions to counteract the force applied by the spring, as will be discussed, so as to retain the brush. Extending through the support member 230 and proximate the commutator receiver 160 is an open slot 340, shown clearly in FIG. 4A. The slot 340 is provided to allow any fragments or particles from the brush 30 to exit the end plate 60 so that they do not accumulate, while also allowing cooling air from the fan assembly 14 to pass therethrough to cool the brushes 30. In the embodiment shown, the slot 340 is proximal the outer member 220. However, in other embodiments, an appropriately sized slot could extend anywhere through the support member 230. It is believed, however, that by placing the slot 340 proximal the member 220, an indentation 341 can be formed therein so as to allow more airflow over the surface of the brush.

Turning to FIGS. 2 and 3, in order to maintain a continuous contact between the brush 30 and the commutator 24, a torsion spring 400 and associated spring holder 410 are utilized. The spring holder 410 extends substantially perpendicularly from the attachment surface 110 of the end plate 60 and is located at a point that is approximately the center of the radius of curvature of the curvilinear inner and outer members 210, 220. However, it should be appreciated that the spring holder 410 may be located at any desired point with respect to the inner and outer members 210, 220. Continuing, the bias spring 400 comprises a coil 430, from which extends a retaining leg 440 and a bias leg 450. Specifically, an inner diameter of the coil 430 of the spring 400 is dimensioned so as to receive the spring holder 410 therewithin. The retaining leg 440 is held in position by a leg retainer 500 that extends at a substantially right angle from the attachment surface 110 of the end plate 60. Thus, when the spring 400 is placed into use, a torsional force is imparted to the bias leg 450. The bias leg 450 is positioned behind a rear end surface of the brush 30, thereby urging a front end of the brush into continuous electrical contact with the commutator 24. It should be appreciated that the coil 430 may require “winding” or otherwise be preloaded to allow the coil 430 to impart sufficient force to both the retaining leg 440 and biasing leg 450.

It should be appreciated that because the spring holder 410 is located at the center of the path formed by the concentrically arranged inner and outer members 210, 220 in which the brush 30 slides, the bias leg 450 is able to apply force to the same region of the brush 30 as it wears. In other words, as the material comprising the brush 30 is consumed and the brush slides toward the commutator 24, the bias leg 450 applies force in approximately the same location on the brush 30. As such, the amount of force that is applied to the brush 30 by the spring 400 throughout the operating life of the brush 30 is essentially consistent. As such, the amount of sparking that occurs between the commutator 24 and the brush 30 is reduced, thus further extending the life of the brush 30.

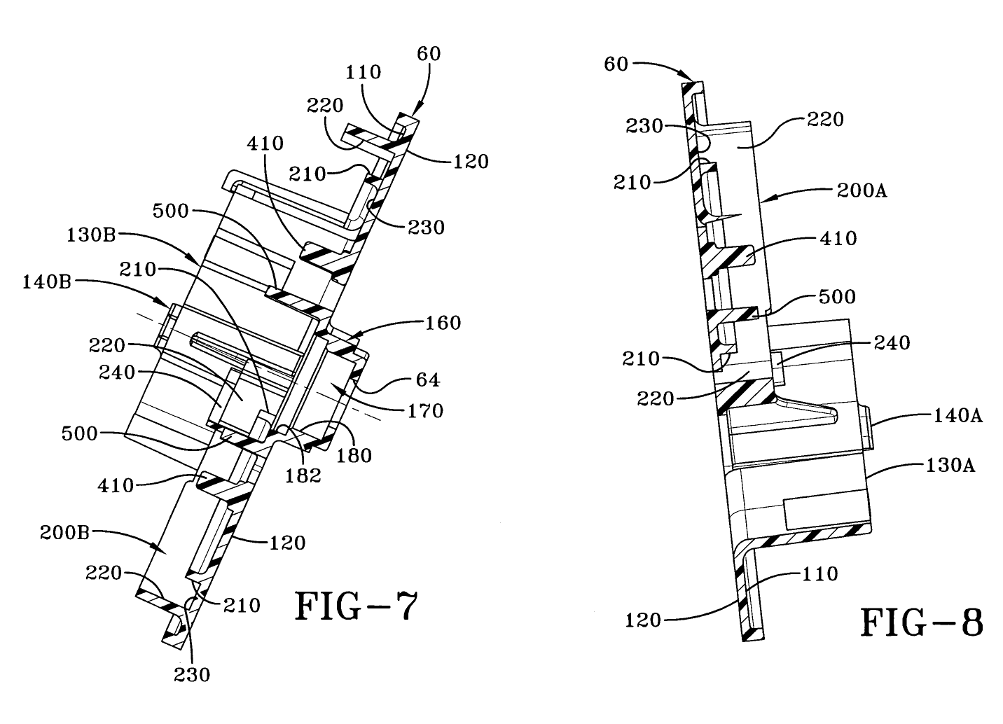

By configuring the brush retainers 200A, B as described above, and as seen in FIGS. 7 and 8, it will be appreciated that a substantial portion of the retained brush is exposed. As a result, air is allowed to flow around the brush so as to maintain the brush at a reduced temperature. Indeed, only two of the brush surfaces—the bottom and the outer curved surface—are covered, while virtually all of the top surface of the brush and most of the inner curved surface are exposed. This configuration also helps to facilitate installation of the brushes inasmuch as the top and side openings of the retainer enable easy insertion of the brush into the retainer.

Therefore, one advantage of the present invention is that a curvilinear brush retainer is able to retain curvilinear brushes so as to allow the length of the brushes to be extended. Another advantage of the present invention is that extended brush lengths can be provided without increasing the size of and end plate which maintains the curvilinear brush retainers. Still another advantage of the present invention is that the curvilinear brush holder provides a spring that provides a consistent amount of force against the curvilinear brush throughout its operating life thereby reducing the sparking between the brushes and the commutator.

Thus, it can be seen that the objects of the invention have been satisfied by the structure and presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. An end plate for an electric motor having a shaft extending from a commutator, said end plate comprising:
a mounting portion having a first surface opposite a second surface, said mounting portion having an opening through which the shaft passes;
a pair of curvilinear brush retainers disposed on said first surface, said retainers extending from said opening, so as to define a curvilinear path; and
a pair of curvilinear brushes, one of which is guided by each said curvilinear path toward the commutator.

2. The end plate of claim 1, wherein the curvature of said path and the curvature of said brushes is about the same.

3. The end plate of claim 1, wherein said curvilinear brush retainers comprises an outer member and an inner member spaced apart by a support member.

4. The end plate of claim 3, further comprising a retention member that extends from either of said outer or inner members toward the other of said outer or inner members.

5. The end plate of claim 3, further comprising an open slot disposed between said outer member and said inner member.

6. An electric motor unit utilizing curvilinear brushes, the motor unit comprising:
a motor assembly having a rotatable shaft;
a fan assembly having a fan coupled to said shaft; and
an end plate carrying said motor assembly and said fan assembly, said end plate comprising:
a plate portion having an attachment surface opposite an inlet surface, said plate portion having an opening through which the shaft passes;
a pair of brush retainers disposed on said attachment surface, said brush retainers comprising a curvilinear outer member, and a curvilinear inner member that are spaced from each other, and which extend axially from said opening, so as to define a curvilinear path adjacent the commutator, said curvilinear path retaining a corresponding one of the brushes.

7. The motor unit according to claim 6, wherein the end plate further comprises a retention member extending transversely from said curvilinear outer member and toward said inner member.

8. The motor unit according to claim 6, wherein the end plate further comprises a slot disposed through said plate portion in a region of said path proximate said opening.

9. The motor unit according to claim 6, wherein the end plate further comprises a bias spring assembly in operative contact with each said brush, said spring assembly configured to urge said brushes toward the commutator.

10. The motor unit according to claim 9 wherein said spring assembly comprises a pair of spring holders centrally arranged with regard to the inner and outer members, said spring holders extending from said plate portion to retain each said bias spring.

11. The motor unit according to claim 10 wherein said spring assembly further comprises a bias spring that has a retaining leg and a bias leg, and said spring holder has a leg retainer to retain said retaining leg, wherein said bias leg is received by an end of the brush so as to be urged toward the commutator.

12. The motor unit according to claim 6, wherein the end plate further comprises a pair of motor brackets extending from said plate portion, said motor brackets configured to retain the motor.

13. The motor unit according to claim 6, wherein said end plate and said brush retainers are formed by an open and shut mold.

14. The motor unit according to claim 6, wherein said plate portion and said brush retainers are formed from thermoset polyester.
